(19) United States
(12) Patent Application Publication
(10) Pub. No.: US 2011/0314969 A1
(43) Pub. Date: Dec. 29, 2011

(54) VIBRATION ABSORBING STRUCTURE OF A HAND TOOL

(76) Inventor: Yung-Shou Chen, Taichung Hsien (TW)

(21) Appl. No.: 12/823,129

(22) Filed: Jun. 25, 2010

(51) Int. Cl. B25D 1/12; B25G 1/01

(52) U.S. Cl. 81/22; 81/489

(57) ABSTRACT

A vibration absorbing structure of a hand tool includes a notch at a bottom side of a wood handle of the hand tool to form a vibration absorbing space when the wood handle is coupled to a tool body. The vibration absorbing space is able to absorb vibrations generated by the tool body when striking and to lower the vibration force.

### BACKGROUND OF THE INVENTION

(a) Field of the Invention

The present invention relates to a vibration absorbing structure of a hand tool and more particularly to a wood handle formed with a notch at a bottom side thereof to form a vibration absorbing space when the wood handle is coupled to a tool body. The vibration absorbing space is able to absorb vibrations generated by the tool body when striking.

(b) Description of the Prior Art

A conventional striking tool comprises a handle, usually a wooden one, and a tool body at a front end of the handle. The tool body can be a hammerhead, an axhead, a shovel head, or any other striking piece according to the demand. The connection of the hand tool is accomplished by inserting the handle into a through hole of the tool body. When the hammer is in use, a counterforce will be generated due to great striking force to cause a great vibration on the wood handle of the hand tool. The user's hand may become numb due to the vibration. It is easy to hurt the user's hand after a long time of use.

In order to eliminate the vibration, the grasp portion of the wood handle can be provided with a plastic handle sleeve. The inside of the handle sleeve can be provided with an air bag to lower the vibration. However, the air bag is complicated and expensive. Besides, the assembly is not convenient.

### SUMMARY OF THE INVENTION

The primary object of the present invention is to provide a vibration absorbing structure of a hand tool, which includes a notch at a bottom side of a wood handle of the hand tool to form a vibration absorbing space when the wood handle is coupled to a tool body. The vibration absorbing space is to absorb vibrations generated by the tool body when striking and to lower the vibration force. The design of the notch is very simple and cost-effective and won't influence the connection of the wood handle and the tool body.

Another object of the present invention is to provide a vibration absorbing structure of a hand tool, which includes top and bottom notches at a top side and a bottom side respectively of the insertion portion to form two vibration absorbing spaces.

The tool body of the hand tool can be a hammerhead, an axhead, a shovel head or any other striking piece.

### BRIEF DESCRIPTION OF THE DRAWINGS

FIG. 1 is a perspective view of a hand tool with the vibration absorbing structure according to the present invention;

FIG. 2 is an exploded view of the hand tool shown in FIG. 1;

FIG. 3 is a side cross-sectional view of the hand tool shown in FIG. 1;

FIG. 4 is an exploded view of a hand tool with another embodiment of the vibration absorbing structure according to the present invention; and

FIG. 5 is a side cross-sectional view of the hand tool shown in FIG. 4.

### DETAILED DESCRIPTION OF THE PREFERRED EMBODIMENTS

Embodiments of the present invention will now be described, by way of example only, with reference to the accompanying drawings.

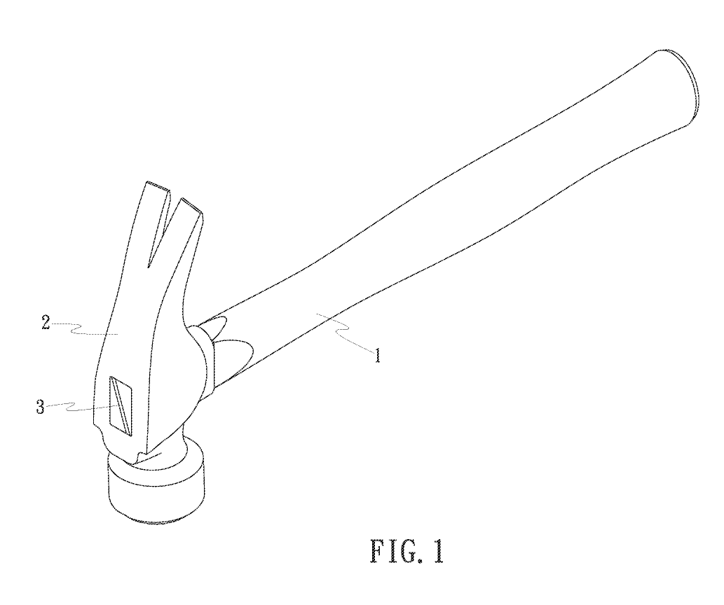

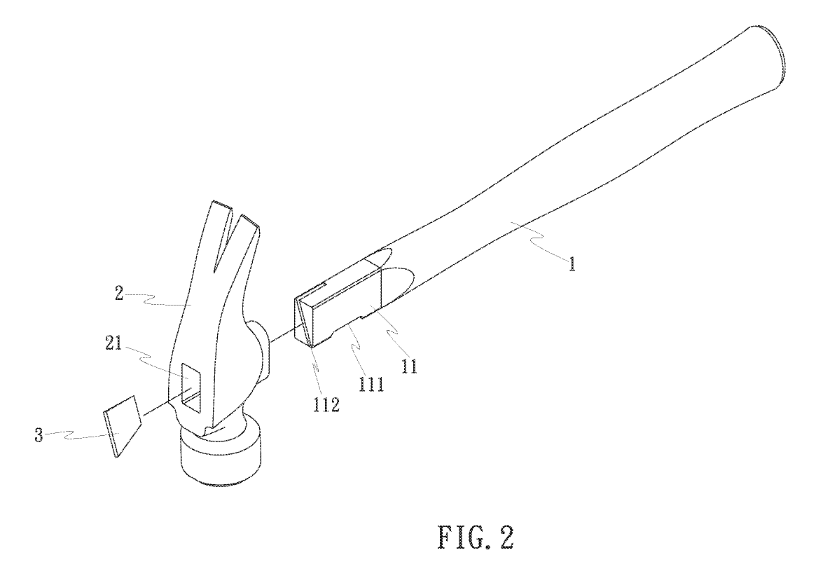

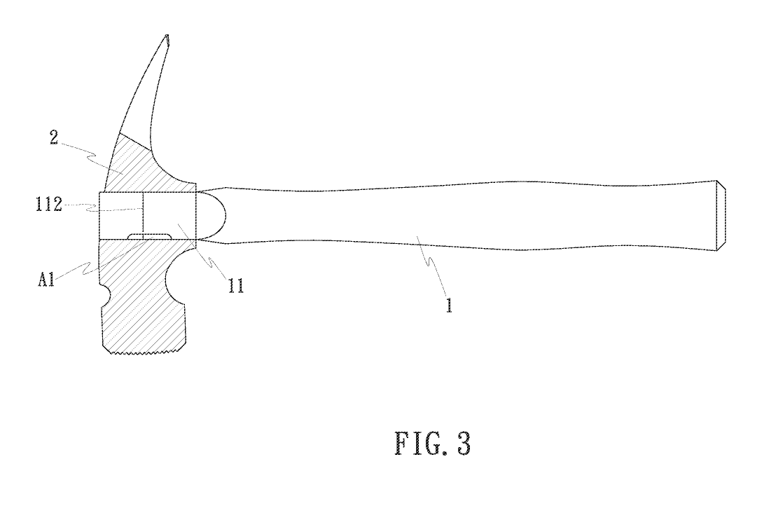

FIG. 1 is a perspective view of a hand tool with the vibration absorbing structure according to the present invention. As further shown in FIG. 2 and FIG. 3, a vibration absorbing structure of a hand tool comprises a handle 1 and a tool body 2. Preferably, the handle 1 of the present invention is made of wood or the like which has similar nature, function and action. In the following description of the embodiments, a wood handle 1 is assumed.

The wood handle 1 has an insertion portion 11 and a notch 111 at a bottom side of the insertion portion 11.

The tool body 2 has a through hole 21. In this embodiment, the tool body 2 is a hammerhead, although the tool body 2 may be an axhead, a shovel head or any other striking piece. In other words, the shape of the tool body 2 is not limited.

The insertion portion 11 of the wood handle 1 is inserted into the through hole 21 of the tool body 2, so that the insertion portion 11 and the tool body 2 are connected together. A vibration absorbing space A1, as shown in FIG. 3, is formed in the notch 111 when the insertion portion 11 is connected to the tool body 2. The vibration absorbing space A1 is adapted to absorb the vibrations generated by the tool body 2 when striking.

The insertion portion 11 of the wood handle 1 can be formed with a wedge slot 112 for insertion of a wedge block 3. After the insertion portion 11 is inserted into the through hole 21 of the tool body 2, the wedge block 3 is inserted into the wedge slot 112 of the insertion portion 11 to tightly fix the insertion portion 11 and the tool body 2 together. The way in which the wedge block 3 and the wedge slot 112 are connected is not limited to this means, but can be done by any other means.

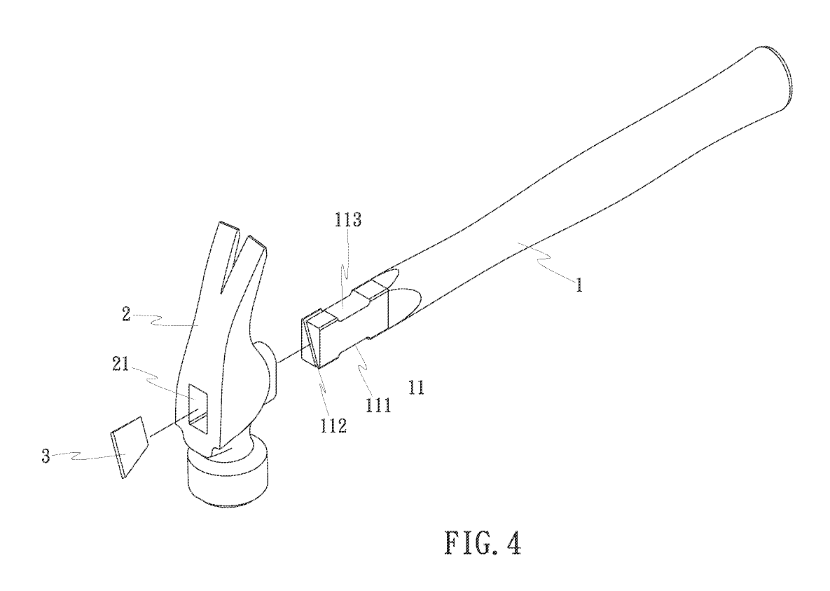

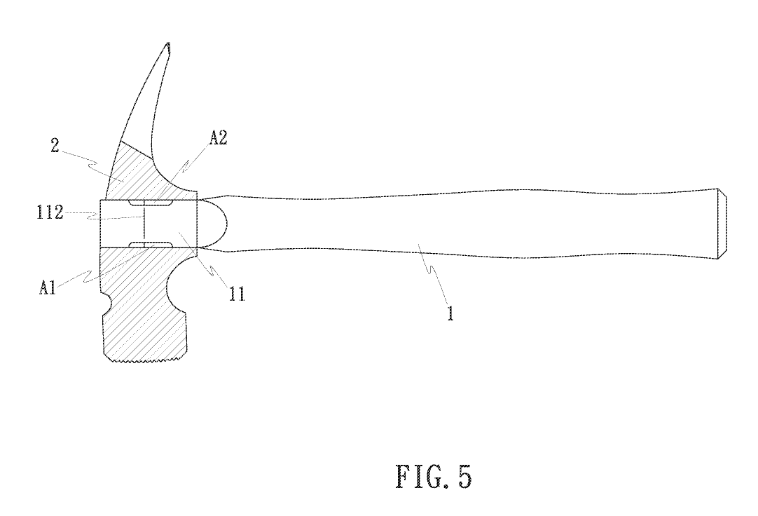

FIG. 4 and FIG. 5 show another embodiment of the vibration absorbing structure according to the present invention. The insertion portion 11 of the wood handle 1 further has another notch 113 at a top side of the insertion portion 11, as shown in FIG. 4, so that the insertion portion 11 has the two notches 113, 111 respectively at the top and bottom sides thereof. When the insertion portion 11 is coupled to the tool body 2, two vibration absorbing spaces A2 and A1, as shown in FIG. 5, are formed in the notches 113, 111 at the top and bottom sides respectively of the tool body 2 to absorb the vibrations.

The vibration space A1 of the present invention can be divided into a plurality of adjacent and smaller vibration absorbing spaces. For example, the notch 111 is formed with a plurality of adjacent and smaller notches, so that a plurality of adjacent and smaller vibration absorbing spaces are formed after the insertion portion 11 and the tool body 2 are connected together. The other vibration absorbing space A2 can be formed in the same way.

The wood handle 1 can be coupled with a plastic handle sleeve or coated with non-slip paint to enhance the vibration absorbing and non-slip functions.

The tool body 2 of the present invention can be a hammerhead, an axhead, a shovel head or any other striking piece.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hand tool with a vibration absorbing structure, the hand tool comprising a wood handle and a tool body;
the wood handle having an insertion portion and a notch formed at a bottom side of the insertion portion;
the tool body having a through hole;
thereby, the insertion portion of the wood handle being inserted into the through hole of the tool body to connect the wood handle and the tool body together, a vibration absorbing space being formed in the notch after the insertion portion is connected to the tool body for absorbing vibrations generated by the tool body when striking.

2. The hand tool with a vibration absorbing structure as claimed in claim 1, wherein the tool body is a hammerhead.

3. The hand tool with a vibration absorbing structure as claimed in claim 1, wherein the insertion portion of the wood handle is formed with a wedge slot for insertion of a wedge block after the insertion portion is inserted into the through hole of the tool body.

4. The hand tool with a vibration absorbing structure as claimed in claim 1, wherein the insertion portion of the wood handle further has another notch at a top side of the insertion portion so that the insertion portion has the two notches respectively at the top and bottom sides thereof to form two vibration absorbing spaces.

5. The hand tool with a vibration absorbing structure as claimed in claim 1, wherein the notch on the insertion portion is formed of a plurality of adjacent and smaller notches.
